(19) United States
(12) Patent Application Publication
(10) Pub. No.: US 2017/0372684 A1
(43) Pub. Date: Dec. 28, 2017

(54) PIANO PEDAL DEPRESSING DEVICE

(71) Applicant: ROSE M. SCHUBERT, JOLIET, IL (US)

(72) Inventor: ROSE M. SCHUBERT, JOLIET, IL (US)

(21) Appl. No.: 15/619,250

(22) Filed: Jun. 9, 2017

Related U.S. Application Data
(60) Provisional application No. 62/355,240, filed on Jun. 27, 2016.

(51) Int. Cl. G10C 3/26; G10C 3/16

(52) U.S. Cl. CPC G10C 3/26; G10C 3/166

(57) ABSTRACT

The piano pedal depressing device helps a user to depress a piano pedal using his or her upper leg. The device can be positioned between a keyboard and a horizontal support surface upon which the piano rests. The piano pedal depressing device includes an adjustable support housing and an actuator assembly, which are operatively connected to each other.

### CROSS-REFERENCE TO RELATED APPLICATION

This application claims the benefit of U.S. Provisional Patent Application Ser. No. 62/355,240, filed Jun. 27, 2016.

### BACKGROUND OF THE INVENTION

### 1. Field of the Invention

The present invention relates to a device for assisting a user to depress a piano pedal. More particularly, the invention relates to a piano pedal depressing device that can be used to engage a piano pedal by movement of a user's upper leg.

### 2. Description of the Related Art

Conventional pianos include pedals which are foot-operated levers located at the base of a piano. Most pianos are equipped with three pedals, a soft pedal (or una corda), a sostenuto pedal, and a sustaining pedal (or damper pedal). The piano pedals change the instrument's sound, enabling the user to achieve a desired sound when playing the piano. The damper pedal (which in general is the rightmost pedal) is the most frequently used of all pedals, and is also the most essential to playing certain pieces or arrangements. One disadvantage of the pedal's location at the base of the piano is that users with shorter legs or users with a handicap, are unable to engage the damper pedal. As such, these users cannot make full use of the piano.

Accordingly, there exists a need for an apparatus that permits a handicapped person, or a person with relatively short legs (such as a child) to engage and depress the damper pedal of a piano or keyboard using his or her thigh or knee. Thus, a piano pedal depressing device solving the aforementioned problems is desired.

### SUMMARY OF THE INVENTION

The piano pedal depressing device allows a user to depress a piano pedal using his or her upper leg, e.g., knee or thigh. The piano pedal depressing device is a portable, adjustable accessory that can be detachably connected to a piano. The device includes a support housing configured for positioning between a keyboard and a support surface, an actuator assembly in the housing, and a swivel arm extending from the housing and connected to the actuator assembly. The housing includes a plurality of sidewalls, a base, and an upper compressible member for securely positioning the piano pedal depressing device between a piano and a support surface. The actuator assembly includes an elongate shaft for selectively contacting the piano pedal. Movement of the swivel arm, initiated by the user, can cause the shaft to depress the piano pedal.

These and other features of the present invention will become readily apparent upon further review of the following specification and drawings

### BRIEF DESCRIPTION OF THE DRAWINGS

FIG. 1 is an environmental front sectional view of a piano pedal depressing device, in accordance with the present invention, operatively connected to a conventional piano.

FIG. 2 is a side sectional view of the piano pedal depressing device of FIG. 1, operatively connected to a conventional piano.

FIG. 3 is an enlarged sectional view of an exemplary rack and pinion assembly for controlling movement of components of the piano pedal depressing device.

Similar reference characters denote corresponding features consistently throughout the attached drawings.

### DETAILED DESCRIPTION OF THE PREFERRED EMBODIMENTS

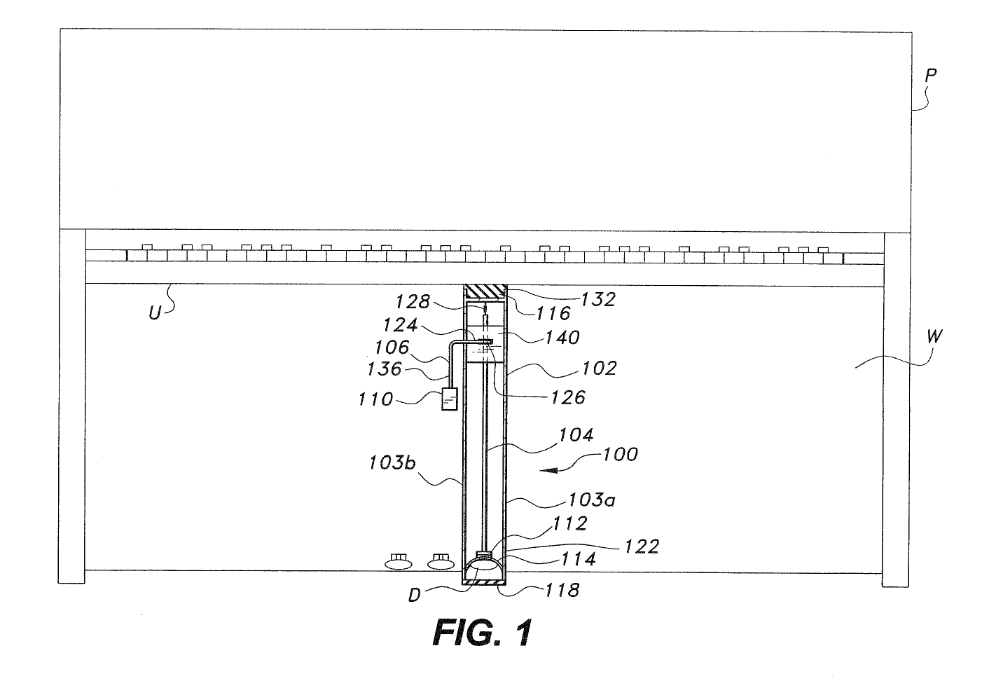

Referring now to FIG. 1, there is shown a piano pedal depressing device configured for connection to a piano P, generally referred to as 100. The piano pedal depressing device 100 permits a user to depress a piano pedal D (such as a damper pedal) located at the base of the piano P, using his or her upper leg portion. The piano pedal depressing device 100 includes an adjustable support housing 102, a swivel arm 136, and an actuator assembly 120, which are operatively connected to each other, in order to facilitate depressing the pedal D.

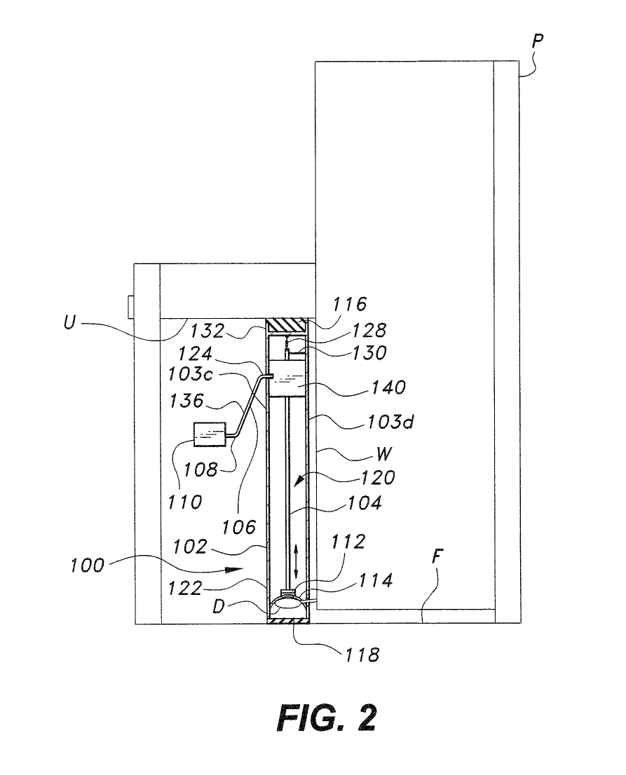

The piano pedal depressing device 100 has a generally elongate body, adapted for being removably positioned between an undersurface U of the piano keyboard portion and a floor, or horizontal support surface. As illustrated in FIGS. 1 and 2, the support housing 102 includes a plurality of sidewall members 103a, 103b, 103c and 103d forming the body of the support housing 102, a base member 118, and a compressible member 116.

As illustrated, the compressible member 116 is provided generally at a first or proximal end 132 of the support housing 102, and is configured to engage the underside portion U of the piano's keyboard. The base 118 is provided generally at an opposing distal end 122 of the support housing 102, and configured to engage the floor or surface upon which the piano P is positioned. The compressible member 116 may include a resilient pad and/or a biasing member, such as a spring loaded pressure system, which can be compressed to accommodate a wide variety of conventional pianos having various distances between the piano underside U and the floor.

The base 118 may include a shock absorbent member, such as a rubber pad, to absorb pressure created when using the device 100, and to stabilize the piano pedal depressing device 100 on the floor. As illustrated, the base 118 may have an arcuate shaped portion 114 with a gap or opening configured to receive the pedal D therein.

The actuator assembly 120 includes a dowel rod or shaft 104, that extends substantially along the length of the housing 102. In an embodiment, the actuator assembly 120 further includes a biasing spring 128 and a pivot arm 130 that are connected to the shaft 104. The shaft 104 is configured to provide reciprocating upward and downward movement within the support housing 102. The pivot arm 130, connected to wall 103d, is configured to selectively pivot up and down to facilitate the downward and upward vertical movement of the shaft 104. A lower end of the shaft 104 includes an adjustable member 112 that can be vertically adjusted to lengthen or shorten the shaft 104. It is to be understood that the adjustable member 112 can be padded (e.g., rubber padded) to prevent, such as substantially prevent, the adjustable member 112 from either sliding off of the pedal D or from making a clicking sound once the adjustable member 112 is lowered against the pedal D.

In an embodiment, the swivel arm 136 can be connected to a rack and pinion assembly 140 of the actuator assembly 120. The rack and pinion assembly 140 can include a gear member 144 supported by a shaft 148 and a spring member 146. A rack 142 is fixedly connected to the shaft 104. The rack 142 has a plurality of gear teeth 152 configured to engage the gear member 144. A spring 146 is connected to the gear member 144. A second shaft member 150 can be provided to support a portion of the swivel arm 136 within the assembly 140.

The swivel arm 136 can have a first lateral portion 124, a second lateral portion 108, and a generally angled portion 106 that extends between the first lateral portion 124 and the second lateral portion 108. The second lateral portion 108 can be configured to have an adjustable length to accommodate a variety of individuals. The second lateral portion 108 can be formed from telescoping members, for example. The first lateral portion 124 extends within the housing 102. A connecting member 126 is positioned between the gear member 144 and the first lateral portion 124 of the swivel arm 136. The second lateral portion 108 and the generally angled portion 106 extend outside of the housing 102. A pad or cushion member 110 can be formed generally at the end of the second lateral portion 108.

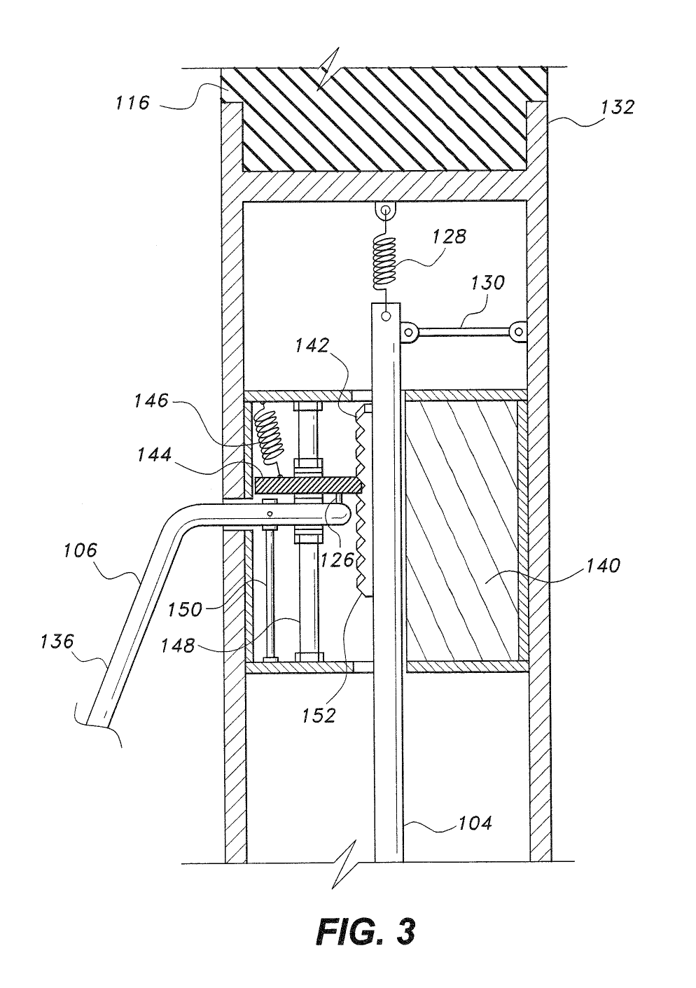

The swivel arm 136 is adapted to move in a generally radial direction relative to the shaft 104, when pressed by the user's upper leg. The pad member 110 provides a soft surface against which the user may press his or her upper leg to move the swivel arm 136. For example, movement of the swivel arm 136 can be configured to adjust the position of the gear member 144 in the rack 142 described above. The spring 146 can bias the gear member 144 in an opposing direction than that of actuation. Upon movement of the swivel arm 136 by the user, the shaft 104 is moved to an engaged position. When the swivel arm 136 is released by the user, the pedal member D provides a biasing force to move the shaft 104 up, back to an unengaged or start position. The rack and pinion assembly 140 converts rotational movement of the swivel arm 136 into vertical movement of the shaft 104, as illustrated in FIG. 3. Thus, the swivel arm 136 can be rotated to move the shaft 104 downward inside the support housing 102 and engage the pedal D. It should be understood that while a rack and pinion assembly has been described, the actuator assembly may include any suitable structure to convert rotational movement of the swivel arm into vertical movement of the shaft.

In operation, the user attaches the piano pedal depressing device 100 to the piano P by aligning the base of the piano pedal depressing device over the pedal D and positioning the compressible member 116 against the underside of the piano P. The piano pedal depressing device 100 is positioned such that the shaft 104 is aligned vertically with the pedal D. A user can press against the pad 110 of the swivel arm with his or her leg, e.g., inner leg, to cause rotation of the swivel arm 136 and, thereby, rotation of the gear member 144. Movement of the gear member 144 allows the shaft 104 to move in a downward direction. The shaft 104 moves downward, engaging the pedal D. Release of the swivel arm 136 permits the biasing force of the pedal D to force the shaft 104, and swivel arm 136 back to an unengaged starting position.

It is to be understood that the present invention is not limited to the embodiments described above, but encompasses any and all embodiments within the scope of the following claims

I claim:

1. A piano pedal depressing device, comprising:
a support housing including a base at a distal end thereof, an upper compressible member at a proximal end thereof, and a plurality of sidewalls extending between the base and the upper compressible member;
a swivel arm extending from the housing; and
an actuator assembly positioned within the support housing, the actuator assembly including a shaft, the shaft being in communication with the swivel arm and extending substantially along the length of the support housing,
wherein the movement of the swivel arm causes the shaft to move downward and engage a piano pedal.

2. The piano pedal depressing device according to claim 1, wherein the base of the support housing includes an opening configured for receiving the piano pedal therein.

3. The piano pedal depressing device according to claim 1, further comprising a biasing spring and a pivot arm extending between the shaft and the housing.

4. The piano pedal depressing device according to claim 1, wherein the actuator assembly includes a rack and pinion assembly, the rack and pinion assembly being in communication with the swivel arm.

5. The piano pedal depressing device according to claim 1, wherein the base includes a shock absorbent material.

6. The piano pedal depressing device according to claim 5, wherein the shock absorbent material includes rubber.

7. The piano pedal depressing device according to claim 1, wherein the swivel arm includes a first lateral portion at a first end, a second lateral portion at a second, opposing end, and a generally angled portion extending between the first lateral portion and the second lateral portion, the first lateral portion extending into the support housing and the angled portion and second lateral portion extending outside of the support housing.

8. The piano pedal depressing device according to claim 7, wherein the second lateral portion of the swivel arm includes a leg pad.

9. The piano pedal depressing device according to claim 7, wherein the second lateral portion comprises a second telescoping lateral portion.

10. A piano pedal depressing device, comprising:
a support housing including a base, an upper compressible member, and a plurality of sidewalls extending between the base and the upper compressible member;
a swivel arm including a first lateral portion extending into the support housing, a generally angled portion, and a second lateral portion extending outside of the support housing;
an actuator assembly positioned within the support housing, the actuator assembly including a shaft extending substantially along the length of the support housing, and a biasing spring and a pivot arm connected to the shaft and the housing.

11. The piano pedal depressing device according to claim 10, wherein the base of the support housing includes an opening configured for receiving the piano pedal therein.

12. The piano pedal depressing device according to claim 11, wherein the base includes a shock absorbent member.

13. The piano pedal depressing device according to claim 12, wherein the shock absorbent member includes rubber.

14. The piano pedal depressing device according to claim 10, wherein the actuator assembly includes a rack and pinion assembly, the rack and pinion assembly being in communication with the swivel arm.

15. The piano pedal depressing device according to claim 10, wherein the second lateral portion of the swivel arm includes a leg pad.
